(19) United States
(12) Patent Application Publication
(10) Pub. No.: US 2015/0317523 A1
(43) Pub. Date: Nov. 5, 2015

(54) VEHICLE-RELATED VIDEO PROCESSING SYSTEM

(71) Applicant: International Business Machines Corporation, Armonk, NY (US)

(72) Inventors: David Kingsley Clark, Cedar Park, TX (US); Bryce Allen Curtis, Round Rock, TX (US); Mark Daniel Rogalski, Leander, TX (US); Kelvin Wayne Sumlin, Austin, TX (US)

(73) Assignee: International Business Machines Corporation, Armonk, NY (US)

(21) Appl. No.: 14/268,281

(22) Filed: May 2, 2014

(51) Int. Cl. G06K 9/00; G08B 21/02; H04N 7/18; G06K 9/32

(52) U.S. Cl. CPC G06K 9/00791; G06K 9/3258; G08B 21/02; H04N 7/181

(57) ABSTRACT

A method, program product and implementing computer system are provided in which one or more a vehicle mounted cameras provide a video feed of the areas surrounding a camera-equipped (CE) vehicle to an on-board computer system for analysis and processing. The computer system determines which if any nearby vehicles pose an increased risk to the driver of the camera-equipped vehicle by analyzing image information obtained by the CE vehicle to determine unsafe driving patterns and/or an unsafe rate of closure of the nearby vehicle relative to said CE vehicle. The CE vehicle is also operable for accessing vehicle information contained in remote computer databases using a detected license plate number of nearby vehicles and informs the driver if the database record of the nearby vehicle indicates a possible current threat to the camera-equipped vehicle. CE vehicle performance data may also be acquired at times when CE vehicle images are taken, and such data may be associated with corresponding images and sent along with the images to be saved at remote computer systems for current and/or subsequent access and analysis.

### FIELD OF THE INVENTION

The present invention relates generally to information processing systems and more particularly to a methodology and implementation for processing information obtained by one or more on-board vehicle video systems.

### BACKGROUND OF THE INVENTION

Today's crowded, high speed driving conditions call for a system to aid driver safety. Some currently available systems are operable to inform a driver of roadway and/or routing conditions on a given day along a selected route but there are no currently available systems directed to obtaining and saving a real-time record of, and alerting a driver concerning, dynamic safety conditions that may affect a driver of a specific vehicle.

Thus there is a need for an improved methodology and implementing system which provides more personalized safety condition information to a user regarding current safety conditions relevant to a specific driver in a specific vehicle at a given point in time, and also, saving a record of such conditions for subsequent availability.

### SUMMARY OF THE INVENTION

A method, program product and implementing computer system are provided in which one or more a vehicle mounted cameras provide a video feed of the areas surrounding a camera-equipped (CE) vehicle to an on-board computer system for analysis and processing. The computer system determines which if any nearby vehicles pose an increased risk to the driver of the camera-equipped vehicle by analyzing image information obtained by the CE vehicle to determine unsafe driving patterns and/or an unsafe rate of closure of the nearby vehicle relative to said CE vehicle. The CE vehicle is also operable for accessing vehicle information contained in remote computer databases using a detected license plate number of nearby vehicles and informs the driver if the database record of the nearby vehicle indicates a possible current threat to the camera-equipped vehicle. CE vehicle performance data may also be acquired at times when CE vehicle images are taken, and such data may be associated with corresponding images and sent along with the images to be saved at remote computer systems for current and/or subsequent access and analysis.

### BRIEF DESCRIPTION OF THE DRAWINGS

A better understanding of the present invention can be obtained when the following detailed description of an exemplary embodiment is considered in conjunction with the following drawings, in which:

FIG. 1 is an illustration of an exemplary embodiment of a system in which the present invention may be implemented;

FIG. 2 is a block diagram showing several of the major components of a user warning system in accordance with the present invention;

FIG. 3 is an illustration of an exemplary driving situation in which the present invention may be implemented with regard to a driver and several surrounding vehicles;

FIG. 4 is an illustration of an exemplary camera image of a vehicle showing a typical license plate mounting containing an alphanumeric string of characters useful in identifying the particular vehicle;

FIG. 5 is a flow chart illustrating an exemplary operation in one exemplary embodiment of the present invention; and

FIG. 6 is a flow chart illustrating an alarm process which may be implemented in accordance with the present invention.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects. As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips, optical disks (e.g., compact disk (CD), digital versatile disk (DVD), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

The various methods discussed herein may be implemented within a typical computer system which includes processing means, memory, updateable storage, input means and display means, in combination with a global positioning system (GPS) and communication means for communicating information between individual user systems and a central server system accessible by users of the system. Since the individual components of a computer system which may be used to implement the computer functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

The on-board computer can, inter alia, identify two or more types of threats from other nearby vehicles. For example, the disclosed system is enabled to identify immediate threats posed by the other driver's current driving behavior (i.e. speed differential, frequent lane changing, swerving, etc.). The disclosed system is also enabled to determine a statistical threat determined from past vehicle history (i.e. number of accidents involved in, traffic tickets associated with nearby vehicles.

For immediate threats, the on-board computer can analyze the video for vehicle positional information in conjunction with the drivers known speed, looking for behaviors that could pose a danger. If such vehicles are found, the computer informs the driver to be on the lookout for an immediate threat. This could be via audible alarms, synthetic voice alarms, heads-up display, or physically such as via seat vibration. Camera(s) can identify vehicles in proximity to CE vehicle and track their position and size within images over time to determine, for example, the rate of closure with CE vehicle. Vehicles will appear larger as they approach the CE vehicle. The change of size over time allows calculation of closure rate. High closure rates are potentially dangerous. Further, aggressive driving behavior can be associated with vehicles making very quick or multiple lane changes over a short time. Such driving behavior can be detected as an indication of an unsafe driving pattern and provide a basis for an alarm to be activated in the CE vehicle. DUI behavior may be indicated by the detection of a vehicle swerving within a lane or frequently crossing over lane markings. These indicators are sometimes subtle and are not noticed by drivers not trained to look for them. A computer visual system is ideally suited to monitor for this type of driving behavior.

For statistical threat information, the on-board computer can recognize license plates within the video and determine the license plate number (using existing image analysis technology.) The license plate numbers are wirelessly sent to a server which accesses department of motor vehicles or other available public and/or private insurance industry databases to collect information about the vehicle's accident and traffic ticket history. If a vehicle is found to have a significantly elevated risk, the computer informs the driver using a relatively less urgent mechanism that there is an elevated risk by being near the subject vehicle, perhaps via an in-dash warning indicator. In one example, a driver is enabled to input to a preference screen (not shown) on a display device in the vehicle to associate a relative urgency level to predetermined types of vehicle incidents which may be identified in a license plate search.

CE vehicle performance data may also be acquired at times when CE vehicle images are taken, and such data may be associated with corresponding images and sent along with the images to be saved at remote computer systems for current and/or subsequent access and analysis.

Warning indicators which may be implemented in connection with the disclosed system include but are not limited to audible, visual and vibrating seat alarms of varying intensities, and various combinations of such alarms for different situations. In one example, the user may be presented with an input screen on an in-vehicle display such that the user may select which alarms are activated for which driving situations. For example a driver may wish to have a vibrating seat alarm and an audio and visual alarm activated concurrently when erratic driving behavior is detected for a nearby vehicle while, at the same time, the driver may wish to have only a softer audio alarm or voice alarm sounded when it is determined that an identified nearby vehicle has had several moving vehicle violations in the recent past. The driver may also input if certain kinds of driver violations are to be treated more seriously than others. For example, DUI violations associated with a nearby vehicle may be treated as more of a present threat to a driver than parking violations and a violation occurring within the most recent six months for example may be processed as more of a current threat, and therefore result in a more pronounced alarm, than violations which occurred more than six months ago. The precise algorithm and associated alarms may be input to an onboard alarm and processing system by a driver before a trip or determined ahead of time by the driver or a third party such as an automobile manufacturer. The alarm system may also be selectively de-sensitized or even inactivated by a driver for example when the driver will be driving in a low speed limit and/or crowded driving environment, and does not want to be notified.

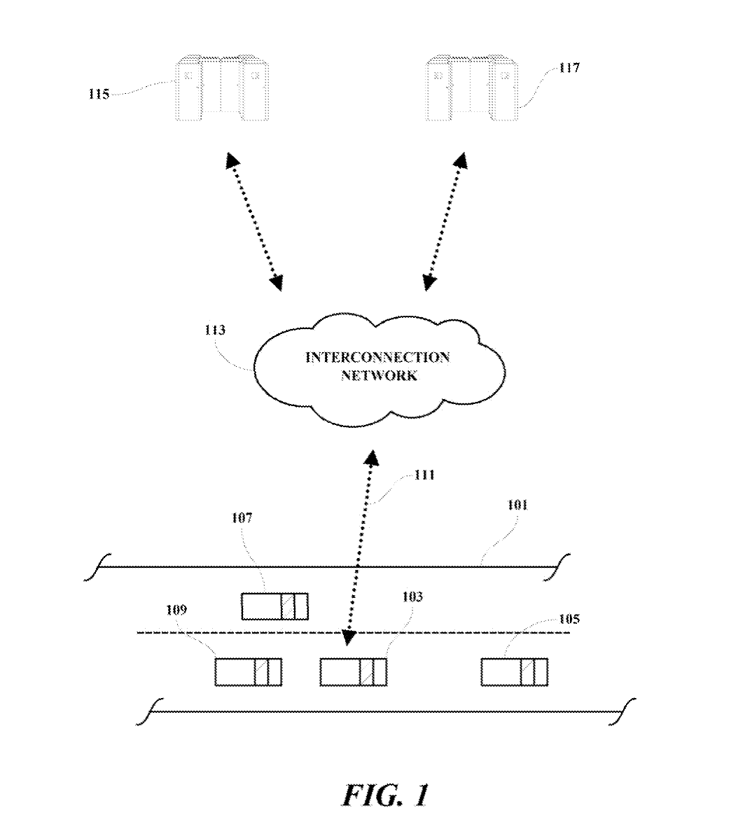

In FIG. 1 there is shown a highway 101 and four vehicles traveling thereon 103-109. Vehicle 103 is a camera-equipped (CE) vehicle which includes one or more cameras mounted thereon as shown in more detail in FIG. 3. As used herein, vehicle 105 is referred to as a “leading vehicle”, i.e. vehicle 105 is leading or ahead of CE vehicle 103. Vehicle 109 is a “trailing vehicle”, i.e. vehicle 109 is trailing the CE vehicle 103, and vehicle 107 is a “passing vehicle”, i.e. vehicle 107 is shown passing the CE vehicle 103 in the illustrated example. The CE vehicle 103 includes an on-board processing system arranged for, inter alia, processing images and/or video clips which are acquired by the on-board cameras.

The on-board processing system also includes a communication device for selectively communicating 111 with servers 115 and 117 for example through an interconnection network 113. Servers 115 and 117 may be public and/or private servers which include vehicle information databases accessible by the CE vehicle 103 to return accident-related information in which an identified vehicle has been involved. The vehicle databases may include, for example, the color, make, model and year of a vehicle and also the State of Registration and inspection status for the vehicle. Other retrievable information would include the type of and the number of vehicle incidents by date in which a searched-for or “subject” vehicle has been involved during a predetermined past period of time leading up to and including real-time or current information. The vehicle information databases may also be arranged to selectively provide images from various perspective views of a subject vehicle which may be downloaded to and displayed upon a display device of a CE vehicle in response to a license plate input from the CE vehicle to one or more vehicle information databases. It is noted that all of the vehicle information requested by a CE vehicle may not be stored at only one of the databases and therefore the system is designed to access one or more vehicle information databases to acquire all of the vehicle information required by a specific vehicle information accessing application.

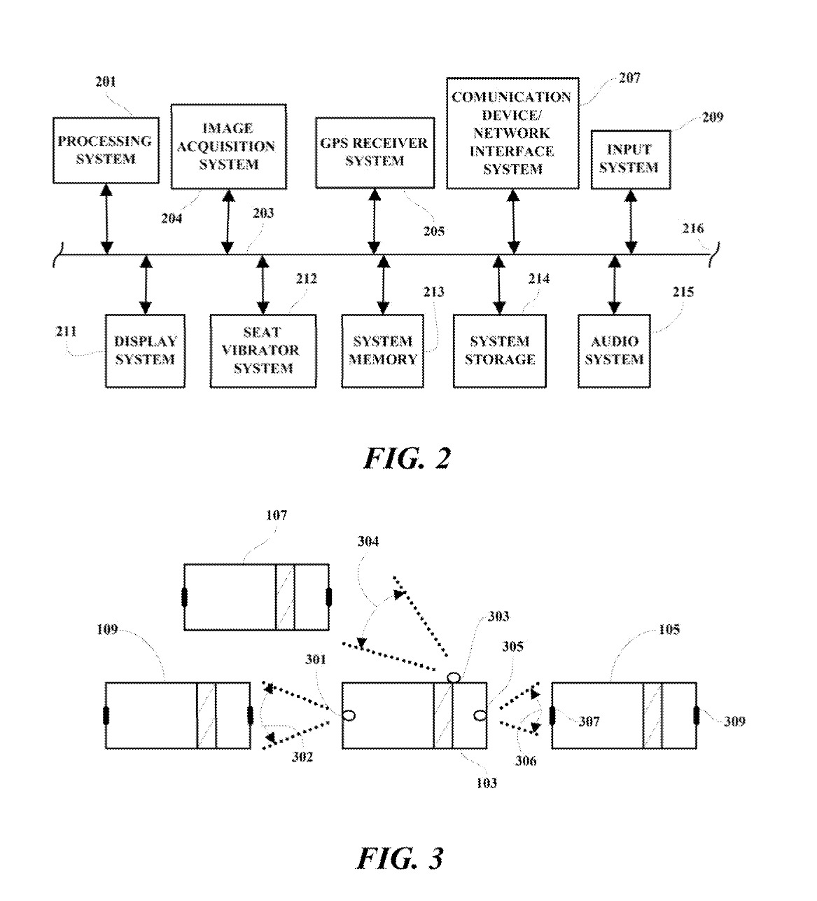

In FIG. 2, several components of a vehicle's onboard vehicle information acquisition system are illustrated. As shown, a processing system 201 is connected to a main system bus 203. An image acquisition system 204 is also connected the bus 203. The image acquisition system 204 includes, inter alia, one or more cameras (as shown in more detail in FIG. 3) arranged for acquiring images of vehicles nearby the CE vehicle 103 as the CE vehicle travels along a roadway. A GPS Receiver System 205 is also shown coupled to the main system bus 203. Additional systems connected to the main bus 203 include a Communication Device and Network Interface System 207, an input system 209, a display system 211, a seat vibrator system 212, a system memory 213, a storage system 214 and an audio system 215. Additional systems may also be connected to the main bus 203 as indicated 216. All of the various systems within the vehicle's onboard vehicle information acquisition system shown in FIG. 2 are interconnected and arranged to communicate with each other over the system bus 203.

FIG. 3 shows an illustration useful in explaining an exemplary operation of the disclosed onboard vehicle information acquisition system within the CE vehicle 103. As shown, the CE vehicle 103, in the present example, includes three cameras mounted thereon, a rearward viewing camera 301, a side viewing camera 303 and a forward viewing camera 305. The cameras may be mounted in any available position on the CE vehicle 103 in order to acquire respective viewing angles 302, 304 and 306 as shown. The cameras may, for example, be mounted near the top of the rear window to obtain a rearward view 302, along with the driver-side rear-view mirror to obtain a passing lane view 304 or in a convenient position on the front grill area to obtain a forward-looking view 306. The CE vehicle 103 may also include other mounted cameras, for example, inter alia, on the passenger side rear view mirror. The cameras shown in the example may be still cameras programmed to take images every so often or they may be video cameras which acquire a stream of images of which sample images may be taken every so often. When positioned as illustrated, the CE vehicle 103 is enabled to acquire images of areas and other vehicles e.g. 109 behind the CE vehicle 103, as well as images of areas and vehicles e.g. 107 that may be passing the CE vehicle 103, and even images of areas and vehicles e.g. 105 that are traveling ahead of the CE vehicle 103.

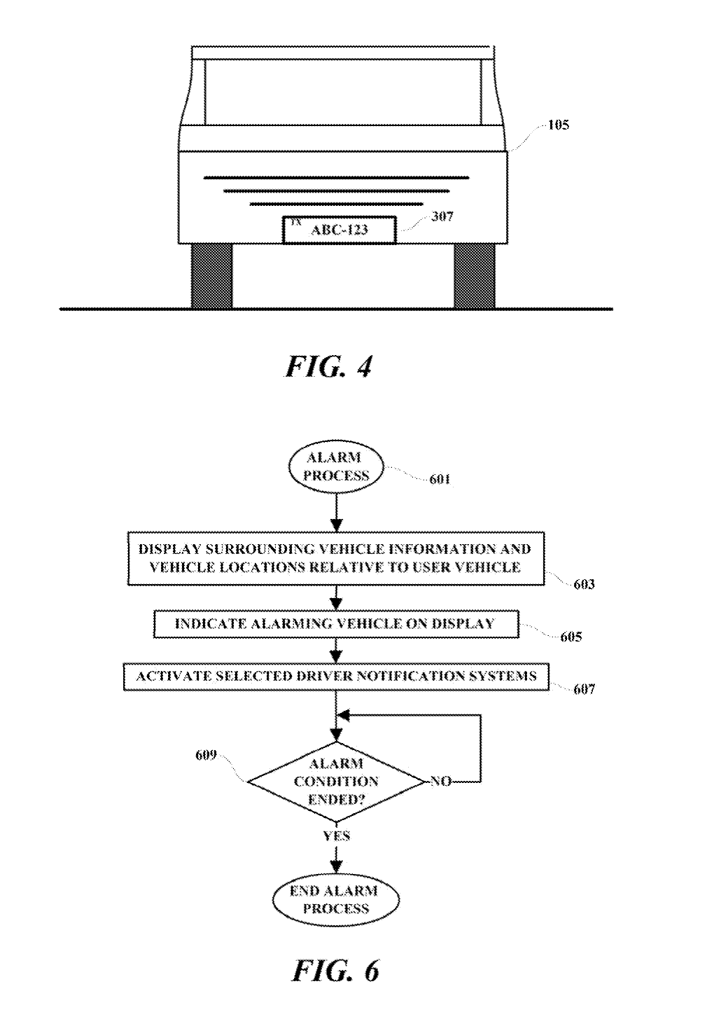

For example, as shown in FIG. 4, camera 305 mounted on the CE vehicle 103 is arranged to obtain an image of the rear of the leading vehicle 105, which includes the license plate 307 of the leading vehicle 105 including the license plate number and the State of Registration. With this image, the onboard vehicle information acquisition system shown in FIG. 2 is able to isolate the license plate number i.e. “ABC-123” and even the State of Registration i.e. “TX”, and send that vehicle identification as an input to one or more vehicle information servers 115, 117, to receive vehicle descriptive information and also vehicle incident and/or accident information. The returned vehicle descriptive information may be used to confirm that the vehicle being searched is in fact the same vehicle as the vehicle on the road leading the CE vehicle.

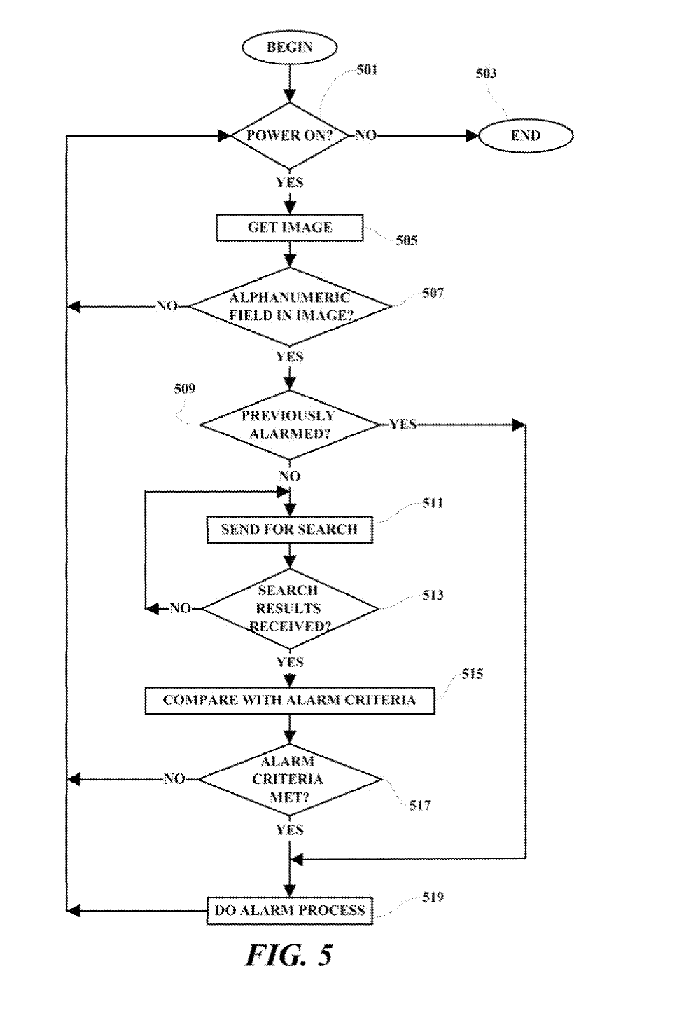

FIG. 5 is a flow diagram for an exemplary operation of the disclosed onboard vehicle information acquisition system within the CE vehicle. The flow diagram is with respect to a single camera and related image processing, it being understood that the same flow is applicable to each camera of a multi-camera on-board system. It is further understood that the flow is with regard to the processing of a single image and is repeated for each image acquired. The system may be pre-set with regard to the how often images are taken and processed. As shown in FIG. 5, when the system is powered on 501, an image of a viewed area is acquired 505 and the image is processed 507 to determine if there is an alpha-numeric field in the image. If there is no vehicle in front of the CE vehicle 103 for example, then no alpha-numeric field will be detected and the process returns to await the next image acquisition. If there is a vehicle e.g. 105 in front of the CE vehicle 103, then the alpha-numeric field of the license plate 307 of vehicle 105 is detected for processing. Next it is determined whether or not the detected license plate number has already been previously searched 509 and determined to be cause for alarm. If the detected license plate number had already been searched and alarmed 509, then the process goes directly to the alarm condition process 519 which is shown in FIG. 6. If, however, the detected license plate number had not previously been searched by the CE vehicle 103, then the plate number and related information such as the detected State of Registration, are sent 511 to appropriate vehicle information server databases and the results of the search of the detected license plate number and/or related information are returned to the CE vehicle 103 for further processing. When the search results are received 513, the results are then compared with predetermined alarm criteria 515 to determine if an alarm process is appropriate. If the predetermined alarm criteria are met 517, then the driver alarm process is activated 519 as shown in FIG. 6.

It is noted that alarm criteria may be predetermined by driver input to an alarm criteria preference screen (not shown) on the display system 211 or input to the system by other entities such as the vehicle manufacturer or other public safety or other organization. As an example, a driver may select alarm criteria as including any speeding violation within the previous six months, any DUI incidents involving the vehicle being searched at anytime within the last year, any hit-and-run or collision incident in which the searched vehicle was involved within the last year, or other similar criteria. The driver of the CE vehicle may also select to associate certain incidents with related alarm types and/or intensities. For example, any DUI incident involving the vehicle being searched at the vehicle information servers may invoke a high alarm condition with a relatively loud audio in combination with an attention-getting video display and a relatively active vibrating seat, while a less severe incident such as a minor accident involving the searched vehicle which occurred more than a year ago, would invoke only a moderate audio alarm.

The alarm process 601 as shown in FIG. 6 may include a display of the vehicles 105, 107 and 109 nearby the CE vehicle 103 to facilitate the process of informing the driver of the CE vehicle as to which nearby vehicle or vehicles is being alarmed upon. For example, if it is determined by a database search that the leading vehicle 105 was involved in a DUI incident during the previous month, then an illustration of relative vehicle positions similar to that shown in FIG. 1, may be presented on the CE vehicle display 603 with the vehicle of concern, i.e. vehicle 105 being presented as a flashing icon 605. Related alarm information may be related to the driver of the CE vehicle 607 using synthetic voice simply verbalizing that the leading vehicle was involved in a DUI incident within the past month. This information may then be used by the driver of the CE vehicle as a warning to move away from the subject alarming vehicle, i.e. the vehicle giving cause for alarm. When the alarming vehicle is no longer within view of the vehicle cameras 301, 303 and/or 305, the alarm condition is ended 609 and the vehicle-mounted cameras return to an automatic monitor and search mode of operation.

In another exemplary embodiment, the actual images captured by one or more cameras of the CE vehicle are automatically and immediately sent to a remote computer system outside of the CE vehicle where the images are saved for subsequent access. As noted earlier, the images may be captured, i.e. pictures taken, automatically at a predetermined frequency and the frequency of image acquisition may be set by a user and/or other authorized entity to provide a record of events occurring nearby a CE vehicle over a period of time. It is also noted that related vehicle performance and/or other CE vehicle-related information such as time-of-day, date, mileage, speed, etc., may also be associated with the images at a time the images are obtained and saved along with the images at a remote server or other remote computer system for subsequent access by authorized entities.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood that the specific example presented herein is not intended to be limiting since the functional combinations disclosed herein may be implemented in many different environments and applications including, for example, applications involving the visualization of business processes and movement of emails, task lists, task list items and other system data components within an overall system data containment environment or application.

The method, system and apparatus of the present invention has been described in connection with an exemplary embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a computer program product comprising one or more computer-readable, tangible storage device(s) and computer-readable program instructions stored on the computer-readable, tangible storage device(s) in any portable or fixed, volatile or non-volatile memory device, including CDs, RAM and “Flash” memory, or other semiconductor, optical, magnetic or other memory device capable of storing code. The disclosed methodology may also be implemented using any available input and/or display systems including touch-sensitive screens and optically-sensitive input pads. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A machine and/or software-implemented method for automatically providing notice to one or more individuals within a first vehicle of vehicle-related information related to a second vehicle, said method comprising:
receiving vehicle-related information detected by a detecting unit on-board said first vehicle, said vehicle-related information being related to said second vehicle, said vehicle-related information being received by said first vehicle automatically without user input;
analyzing said vehicle-related information with regard to predetermined criteria to determine vehicle status information of said second vehicle; and
providing notice to said one or more individuals within said first vehicle of said vehicle status information of said second vehicle.

2. The method as set forth in claim 1 wherein said vehicle status information is related to a legal status of said second vehicle.

3. The method as set forth in claim 1 wherein said vehicle status information is related to a safety record of said second vehicle.

4. The method as set forth in claim 1 wherein said detecting unit comprises one or more image-capturing devices being operated from within said first vehicle.

5. The method as set forth in claim 4 wherein one of said image-capturing devices is a still image camera.

6. The method as set forth in claim 4 wherein one of said image-capturing devices is a moving image video camera.

7. The method as set forth in claim 4 wherein at least one of said one or more image-capturing devices is physically attached to said first vehicle.

8. The method as set forth in claim 4 wherein at least one of said one or more image-capturing devices is coupled to a processing system, said processing system being operable for said analyzing of said vehicle-related information with regard to predetermined criteria to determine vehicle status information of said second vehicle.

9. The method as set forth in claim 1 wherein said analyzing comprises sending said vehicle-related information to one or more server databases over a communication link from said first vehicle, said one or more server databases being configured to contain said vehicle status information for a plurality of vehicles, said method further including using said vehicle-related information to search said databases for said vehicle status information, said method further including sending said vehicle status information from said one or more server databases to said first vehicle for further processing.

10. The method as set forth in claim 1 wherein said providing notice includes one or more notification devices on-board said first vehicle, said one or more notification devices including audio, visual and or physical alerts within said first vehicle of said vehicle status of said second vehicle.

11. The method as set forth in claim 10 wherein said physical alerts include an actuation of a vibrating device within a driver and/or passenger seat within said first vehicle.

12. The method as set forth in claim 1 wherein said vehicle-related information includes a detected license plate number of said second vehicle.

13. The method as set forth in claim 12 wherein said vehicle-related information further includes an identity of a state of registration of said second vehicle.

14. The method as set forth in claim 10 wherein different ones of said notification devices are actuated in response to different types of said vehicle status of said second vehicle.

15. The method as set forth in claim 1 wherein said vehicle-related information includes first and second images of said second vehicle taken at successive times a predetermined time period apart from each other;
comparing locations of said second vehicle relative to said first vehicle for said first and second images of said second vehicle;
using said locations of said second vehicle relative to said first vehicle and said predetermined time period to provide an indication of an unsafe driving pattern for said second vehicle; and
providing notice to said one or more individuals within said first vehicle of said unsafe driving pattern of said second vehicle.

16. The method as set forth in claim 1 wherein said vehicle-related information includes first and second images of said second vehicle taken a predetermined time period apart from each other;
comparing sizes of said first and second images of said second vehicle;
determining a size difference between said first and second images of said second vehicle;
using said size difference and said predetermined time period to calculate a rate of closure of said second vehicle relative to said first vehicle; and
providing notice to said one or more individuals within said first vehicle if said calculated rate of closure of said second vehicle relative to said first vehicle exceeds a predetermined safe rate of closure.

17. A computer program product comprising a computer-readable, tangible storage device(s) and computer-readable program instructions stored on the computer-readable, tangible storage device(s) for automatically enabling a providing of notice to one or more individuals within a first vehicle of vehicle-related information related to a second vehicle, the computer-readable program instructions, when executed by a processing system, being operable for implementing a method comprising:
receiving vehicle-related information detected by a detecting unit on-board said first vehicle, said vehicle-related information being related to said second vehicle, said vehicle-related information being received by said first vehicle automatically without user input;
analyzing said vehicle-related information with regard to predetermined criteria to determine vehicle status information of said second vehicle; and
providing notice to said one or more individuals within said first vehicle of said vehicle status information of said second vehicle.

18. A processing system for automatically providing notice to one or more individuals within a first vehicle of vehicle-related information related to a second vehicle, said processing system comprising:
a processing device;
one or more image-capturing devices being operated from within said first vehicle, said one or more image-capturing devices being coupled to said processing device, said processing device being operable for receiving vehicle-related information detected by said one or more image-capturing devices, said vehicle-related information being related to said second vehicle, said vehicle-related information being received by processing device automatically without user input, said processing device being further operable for analyzing said vehicle-related information with regard to predetermined criteria to determine vehicle status information of said second vehicle; and
one or more notification devices, said one or more notification devices being operable for providing notice to said one or more individuals within said first vehicle of said vehicle status information of said second vehicle.

19. A machine and/or software-implemented method for automatically obtaining image information related to a vehicle environment nearby a camera-equipped vehicle, said method comprising:
automatically obtaining image information by said camera-equipped (CE) vehicle, said image information including images of areas proximate to said CE vehicle, said image information being obtained at a predetermined frequency by one or more camera devices mounted on said CE vehicle;
transmitting said image information from said CE vehicle to one or more remote computer systems outside of said CE vehicle; and
saving said transmitted image information at said one or more remote computer systems for current and/or subsequent access and analysis.

20. The machine and/or software-implemented method as set forth in claim 19 wherein CE vehicle performance data are acquired at times when said images are obtained, said performance data being associated with related ones of said images and sent along with said images and image information to said one or more remote computer systems outside of said CE vehicle.
